(19) United States
(12) Patent Application Publication
(10) Pub. No.: US 2003/0195959 A1
(43) Pub. Date: Oct. 16, 2003

(54) Framework for managing data that provides correlation information in a distributed computing system

(75) Inventors: Eric Labadie, Toronto (CA); Harm Sluiman, Scarborough (CA); David J. Taylor, Waterloo (CA)

Correspondence Address: David A. Mims, Jr., IBM Corporation, Intellectual Property Law Department, 11400 Burnet Road, Austin, TX, 78758, US

(73) Assignee: International Business Machines Corporation, Armonk, NY

(21) Appl. No.: 10/285,995

(22) Filed: Oct. 31, 2002

(30) Foreign Application Priority Data
Apr. 15, 2002 (CA) 2,381,737

(51) Int. Cl. G06F 15/173

(52) U.S. Cl. 709/224; 714/48

(57) ABSTRACT

A framework for managing data that provides correlation information in a distributed computing system is provided. The framework includes a generic correlator data structure and service for generating and managing correlators. The generic correlator data structure defines a generic correlator to uniquely identify a specific event occurring at a specific time on a specific thread of a specific process of a specific application executing on a specific machine in the distributed computing system. The correlator may be used to correlate the specific event with another event, even one occurring on a different machine. The generic correlator data structure may be extended, optionally, to include additional context data, for example, specific information selected by a service, tool or other application requiring the correlators. Preferably, the generic correlator data structure is configured to include an association to a partner correlator for a correlated event. The service generates a correlator for an event of a series of events on a computer within the distributed system with a temporal identifier representative of the unique temporal order of the event in the series of events. The temporal identifier may be defined by one or more sequential counters each responsive a characteristic of the event. The service may provide the correlator for transporting to another computer in the distributed system for associating with a related event correlator. Accordingly, the service may receive a correlator and associate it with the related correlator.

### TECHNICAL FIELD

This invention relates to distributed computing systems, more particularly to a framework for managing data that provides correlation information in a distributed computing system.

### BACKGROUND OF THE INVENTION

Distributed computing is a widely prevalent model for computing systems today. Yet, when problems occur with such systems, analysis is often hampered by the distributed nature of the computing.

Most individual servers in a distributed computing environment are configured, via a logging or other service provider, to generate reasonably useful logs of their own activity. Servers further provide tools to assist a system administrator to analyze the server logs for problem identification. Most middleware applications that facilitate communication between applications also provide a logging service and analysis tools. However, it is common today for a distributed application configuration to include six or more independent servers located on a multitude of physical machines. In such a case, often the best available method to correlate the various error or other event logs from each server is to do so manually, using a time stamp typically associated with each log entry to attempt to recreate a chain of events. The sheer volume of log entries often makes this task impossible. Even where the volume of log entries is low enough not to render the task of manual correlation impossible, the task is at best approximate because the correlator (i.e. the time stamp) is often not sufficiently granular, for example, providing millisecond accuracy when nanosecond accuracy is required. Frequently, the clocks from which the time stamps are derived on the different platforms are not synchronized. It is now recognized that the difficulties in correlating event logs, for example, in order to identify which system is the source of a problem, are a source of difficulty.

Error and other event logs generally lack sufficient correlation information that may enable the log from one system to be meaningfully compared to the log from another, particularly in a distributed computing environment. At present, such systems do not have access to sufficient contextual data particularly as it relates to other systems in the distributed computing environment. Such contextual data may be useful as a correlator between distributed systems. A correlator is data used by a service, tool or other application to associate a first event (e.g. a step taken by a process) with at least one other event. A correlator typically comprises data representative of an event identifier selected from one or more geographical and logical identifiers to specify what event occurred and where and a temporal identifier to specify when the event occurred.

Some service provider applications recognize the need for correlators between events that occur within the same or on separate servers in a distributed application environment. For example, one service application, Tivoli® ARM (application response measurement) measures service response levels for transactions in a distributed environment. Tivoli is a registered trademark of International Business Machines Corporation. ARM employs transaction correlators to provide a capability to break down a transaction into its component parts, so that the contribution of each part to the total response time can be analyzed. In a client/server model of a distributed computing system, for example, transactions often consist of one transaction visible to the user, and any number of nested component transactions that are invoked by the one visible transaction. These component transactions may be referred to as the children of the parent transaction (or the child of another child component transaction). As each component transaction contributes to the total response time of the visible transaction, it is useful to know the response times for each component. This function can be used across components within a single computer, or across multiple computers. The function further assists with transaction path tracing. In accordance with ARM, each application responsible for a component of the overall transaction to be measured is modified to include calls to ARM via an application programming interface (API). The calls may request correlators for transactions with one or more child transactions, send the assigned correlators to the child transaction(s) along with the data needed to invoke the child transaction(s) and pass correlators received from parent transactions to the ARM measurement agents.

ARM measurement agents follow conventions when creating correlators in accordance with a defined format. Included within the correlator is information identifying the computer, the transaction class, the transaction instance, and some flags. The ARM correlator format is somewhat flexible and extendible; however, the correlator and the framework for handling it are specific to the needs of the ARM service. That is, it is not a generic correlator per se for use by one or more varied service applications. Moreover, ARM correlators provide identification only to the level of a transaction instance.

There is therefore a need to provide a framework for managing data that provides improved correlation information in a distributed computing system.

### SUMMARY OF THE INVENTION

An object of the invention is to provide a framework for managing data that provides correlators in a distributed computing system.

In accordance with a first aspect of the invention, there is a method for providing a correlator for an event of a series of events. The method comprises generating a correlator comprising an event identifier and a temporal identifier. The event identifier comprises one or more identifiers selected from the group comprising a geographical identifier of said event; and a logical identifier of said event. The temporal identifier is representative of the order of the event in the series of events.

In accordance with an embodiment of the invention, there is a method for providing a correlator for an event of a series of events occurring on a computer and for which correlators are desired. In accordance with the method, an event identifier is determined from data representative of one or more identifiers selected from the group consisting of geographical identifiers and logical identifiers for the event. A temporal identifier for the event is assigned from data representative of the unique temporal order of the event in the series of events. The correlator is generated from the event identifier and the temporal identifier for the event.

Preferably, to assign the temporal identifier, each event is counted using one or more sequential counters that are responsive to a characteristic of the event. The temporal identifier comprises a count from one or more of the one or more sequential counters. Its process may define a first characteristic of the event. One of the sequential counters may define a process sequential counter responsive to the first characteristic to count all the events of the process. In such a case, the temporal identifier comprises a count of the process sequential counter. Further, a thread of the process generating the event may define a second characteristic of the event. One of the sequential counters thus defines a thread sequential counter responsive to the second characteristic to count all the events of the particular thread of the process. The temporal identifier may additionally comprise a count of the thread sequential counter. In instances where an event may require a correlator for use by more than one provider instrumenting the process, a third characteristic of the event may be defined by the provider requiring the correlator. The thread sequential counter is further responsive to the third characteristic to count all of the events of the said thread for the said provider.

In accordance with a preferred method, there is included a step of providing a generic correlator data structure for defining the correlator. The data structure comprises means for defining the event identifier and the temporal identifier and the step of generating comprises configuring an instance of the data structure. The generic correlator data structure may further comprise means for defining optional context information. As such, the method further comprises the steps of determining data representative of an instance of the optional context information; and configuring the instance of the data structure with the data representative of the instance of the optional context information.

The generic correlator data structure may further comprise means for defining an association between the correlator for the event defined by the data structure and a partner correlator comprising a correlator for a second event. Accordingly, the method further comprises the steps of determining data representative of the association with the partner correlator and configuring the instance of the data structure for the event with the association. Moreover, steps are provided for receiving data for defining a partner correlator for the event and generating an instance of the generic data structure for the partner correlator in accordance with the data received.

In accordance with a preference of the invention, when the computer is coupled to one or more other computers in a distributed computer system, the method further includes the step of providing the correlator for transporting to a first one of the other computers for association with a correlator of a second one of the other computers. It is understood that the first and second other computers need not be different from one another.

Preferably, the method of the invention includes a step of providing the correlator for use to identify the event.

In accordance with a further aspect of the invention, there is provided a computer readable medium for implementing the methods of the invention on a computer. For example, the invention provides a computer readable medium containing executable program instructions for providing a correlator for an event of a series of events occurring on a computer and for which correlators are desired. The computer program medium comprises programming instructions for determining an event identifier comprising data representative of one or more identifiers selected from the group consisting of geographical identifiers and logical identifiers for the event. Programming instructions are further provided for assigning a temporal identifier comprising data representative of the unique temporal order of the event in the series of events from one or more sequential counters each responsive to a characteristic of the event; and generating the correlator comprising the event identifier and the temporal identifier for the event.

In accordance with a further aspect of the invention, there is provided a correlator for an event in a series of events. The correlator comprises an event identifier comprising one or more identifiers selected from the group comprising: a geographical identifier of said event; and a logical identifier of said event; and a temporal identifier representative of the order of said event in said series of events.

In accordance with a preference of the invention, there is a data structure stored on a computer readable medium representing a correlator. The data structure comprises a field for an event identifier comprising data representative of one or more identifiers selected from the group consisting of geographical identifiers and logical identifiers for the event; and a field for a temporal identifier comprising data representative of the unique temporal order of the event in the series of events from one or more sequential counters each responsive a characteristic of the event. In accordance with preferences of the invention, the data structure may further comprise at least one of a field for optional correlation information configured in accordance with a protocol for the exchange of information and a field for providing an association to a partner correlator.

### BRIEF DESCRIPTION OF THE DRAWINGS

Further features and advantages of the present invention will become apparent from the following detailed description, taken in combination with the appended drawings, in which:

FIG. 1 illustrates a system for managing data that provides correlation information on an exemplary distributed computing environment configured in accordance with the invention;

FIG. 2 illustrates a system for managing data that provides correlation information on another exemplary distributed computing environment configured in accordance with the invention;

FIG. 3 illustrates an exemplary correlator class defining a correlator data structure in accordance with an embodiment of the invention;

FIGS. 4A, 4B and 4C show exemplary event occurrence time lines and counter assignments to the events of various process/thread/provider scenarios;

FIGS. 5A and 5B illustrate an object model for a distributed correlator service in accordance with an embodiment of the invention; and

FIGS. 6A, 6B and 6C show a calling sequence for the classes of FIGS. 5A and 5B.

### DETAILED DESCRIPTION OF THE INVENTION

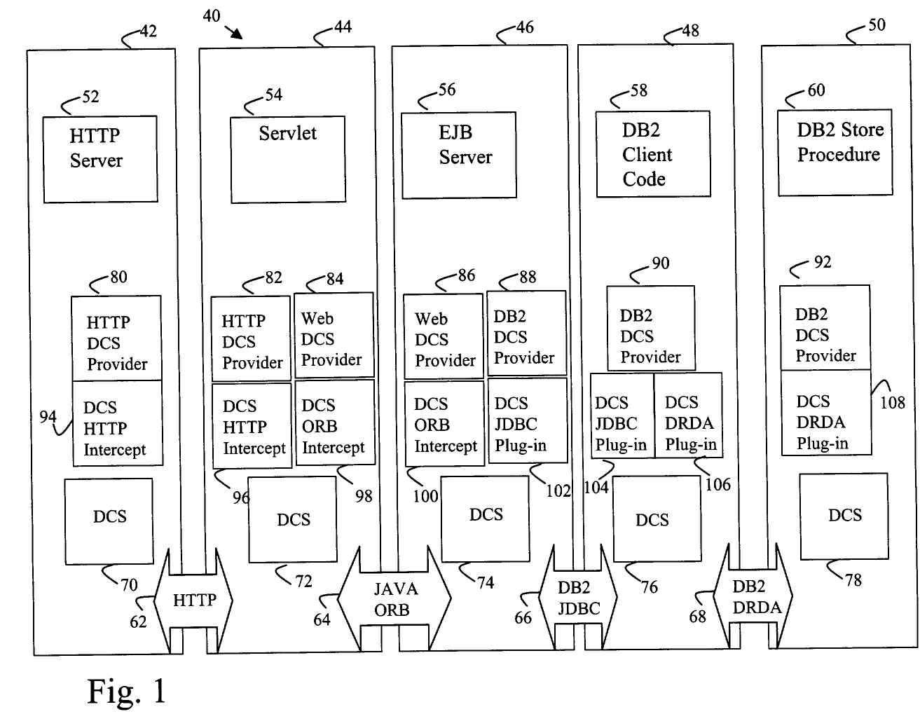

Reference is made to FIG. 1 which shows an exemplary distributed or networked computing system 40, namely an Internet web portal having a database, configured in accordance with the invention. The distributed computing environment 40 comprises a plurality of server platforms, collectively 42-50. The respective server platforms are configured to provide various sever applications, namely, an HTTP server 52, a servlet 54, an Enterprise JavaBeans™ (EJB™) server 56 client database application 58 and a DB2™ store procedure 60 (i.e. database). Enterprise JavaBeans and EJB are trademarks of Sun Microsystems Inc. DB2 is a trademark of International Business Machines Corporation. In exemplary system 40, servlet 54 and EJB server 56 are configured to provide a Java™ (trademark of Sun Microsystems Inc.) technology-based web application server, integrating enterprise data and transactions for networked communication.

As is well understood to persons skilled in the art, a server platform typically comprises a computing station having a powerful processor and high capacity mass storage. The server typically utilizes a multi-tasking operating system allowing multiple applications to run concurrently. While each server platform 42-50 is illustrated as providing a particular server application component, (collectively 52-60) of the distributed computer system 40, it may be understood that an individual server platform may be configured to provide more than one such component.

As illustrated, the server platforms 42-50 are further configured to provide transport or other communication mechanisms, as applicable, to the server applications 52-58. For example, HTTP server 52 is coupled for network communication via HTTP transport 62 to servlet 54. Servlet 54 is in turn coupled to EJB Server 56 via a Java Object Request Broker (ORB) 64. EJB Server 56 facilitates connection of the servlet 54 to client application 58 via DB2 Java database connectivity (JDBC) 66 while the client application 58 and DB2 store procedure 60 are coupled through DB2 Distributed Relational Database Architecture (DRDA®) middleware 68. DRDA is a trademark of International Business Machines Corporation.

In accordance with the invention, there is provided for each component 52-60 of system 40 a distributed computing system (DCS) service 70-78 for managing correlation data that provides correlators in a distributed computing system. Access to each DCS service 70-78 is made via one or more provider plug-ins and one or more transport plug-ins for each server. For example, HTTP server 52 includes HTTP DCS provider plug-in 80 for providing access to DCS service 70 by HTTP server 52. DCS HTTP interceptor plug-in 94 provides a request interceptor to DCS 70 for HTTP transport 62. Similarly, HTTP DCS provider plug-in 82 and Web DCS provider plug-in 84 are provided for servlet 54 while two transport plug-ins, namely DCS HTTP interceptor 96 and DCS ORB Interceptor 98 are provided, one for each of the transport mechanisms 62 and 64 provided by server 44 for accessing DCS service 72. Likewise, respective DCS ORB interceptor 100 and DCS JDBC plug-in 102 are provided for DCS service 74 on server 46. Server 46 also includes Web DCS provider 86 and DB2 DCS provider 88 for respective EJB and DB2 components. Server 48 includes DB2 DCS provider plug-in 90, DCS JDBC transport plug-in 104 and DCS DRDA transport plug-in 106. Server 50 is provided with DB2 DCS provider plug-in 92 and DCS DRDA transport plug-in 108.

As described further herein below, the respective DCS Service, provider plug-ins and transport plug-ins for each particular application provide a framework for managing data providing correlator information. The framework may be invoked to generate a correlator for a particular event of an application. A service provider defined by the provider plug-ins may use the correlator locally, for example, as a part of a log entry for the application. The correlator may be transported to another component of the distributed computing system for association with another event. For example, a correlator of a first event of a server application on a first server may be transported via the transport mechanism coupling the first server application to another server application, particularly one such application implemented on a remote server platform. The sharing of such correlators provides a means to link events occurring on different components of a distributed computing system.

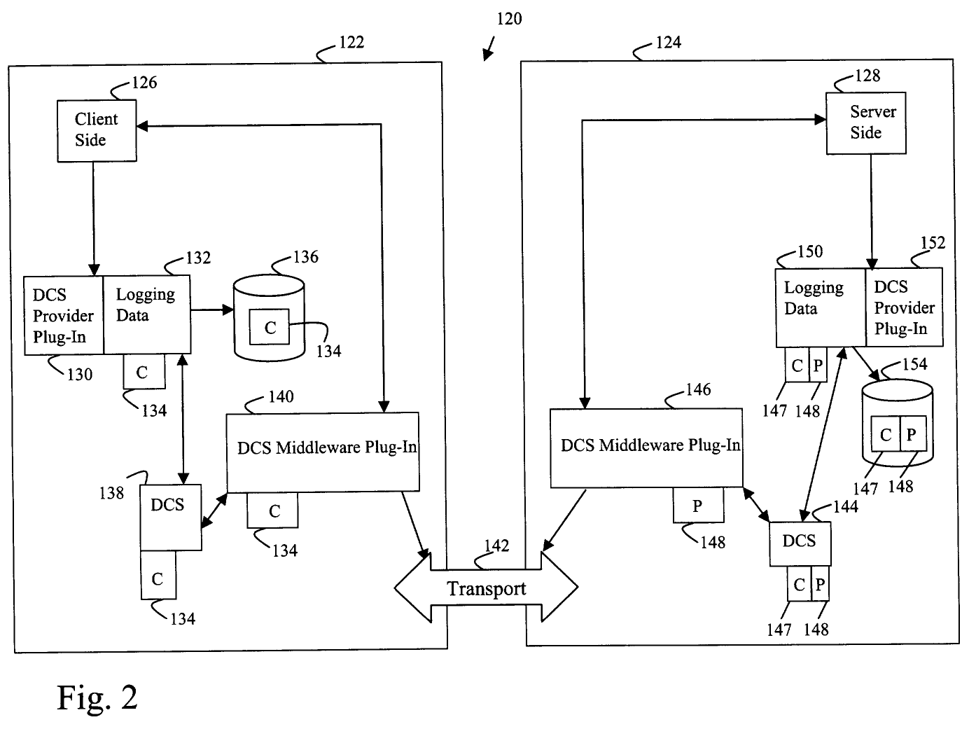

FIG. 2 illustrates another exemplary distributed computing environment comprising a client/server model configured in accordance with the invention. Distributed computing system 120 includes a client system 122 and a server 124 coupled for communication through a network 142, for example, a local area network (LAN). The network 142, in turn, may be connected to other LANs or a wide area network via a gateway (not shown). Client system 122 includes a client side component 126 of a client/server application. Client side component 126 is configured for communication between the client system 122 and the server 124. Client side component 126 may include, for example, interfaces to network 142 providing a transport for handling messages for a function call over network 142. Server 124 includes a server side component 128 configured for communication via network 142 with client side component 126.

In accordance with the invention there is provided on client system 122 a DCS provider plug-in 130 for client side component 126. DCS provider plug-in 130 defines a provider service for the client side component such as a logging service requiring logging data artifacts, for example artifact 132 for client side events and, in some instances, logging data artifact 132 includes a DCS correlator 134, and a partner correlator (not shown) for a corresponding server side event. Provider plug-in 130 is coupled to a storage device 136 for recording an event log including the artifact and correlator 132 and 134 and partner correlators, as applicable. Storage device 136 may be local or remote relative to client system 122.

Provider plug-in 130 is further coupled to a DCS service 138 which generates, stores and provides the DCS correlators (134) when invoked by provider plug-in 130 or a transport plug-in such as DCS Middleware plug-in 140. DCS Middleware plug-in 140 is provided for communicating with DCS service 138 to obtain correlators for transporting to server 124 in network communications over network 142. DCS service 138 also associates correlators received in inbound communications (i.e. partner correlators) with appropriate correlators generated by DCS service 138.

Server 124 includes corresponding middleware plug-in 146, DCS service 144 and DCS provider plug-in 152 that function in a manner similar to their corresponding client side equivalents. Provider plug-in 152 defines a provider service for the server side component 128. The provider service may be a logging service requiring logging data artifacts, such as artifact 150 for server side events including a DCS correlator 147 and, as applicable, a partner correlator 148 for a corresponding client side event. A storage device 154 is coupled, either remotely or locally, to provider plug-in 152 for storing logging data artifact 150 including DCS and partner correlators 147 and 148 in log entries.

When a transport plug-in receives an inbound network communication including a correlator, whether from a client system 122 or server system 124, the correlator is removed and passed to the respective DCS service with which the transport plug-in is coupled in order that the DCS service may associate the inbound correlator as a partner correlator for a correlator generated by the DCS service. This partner correlator is linked to a correlator for an event generated by the DCS Service in response to an invocation by a provider plug-in on the system receiving the partner correlator. This basic mechanism provides a framework for arbitrary applications and systems to create and communicate correlators in a distributed computing environment.

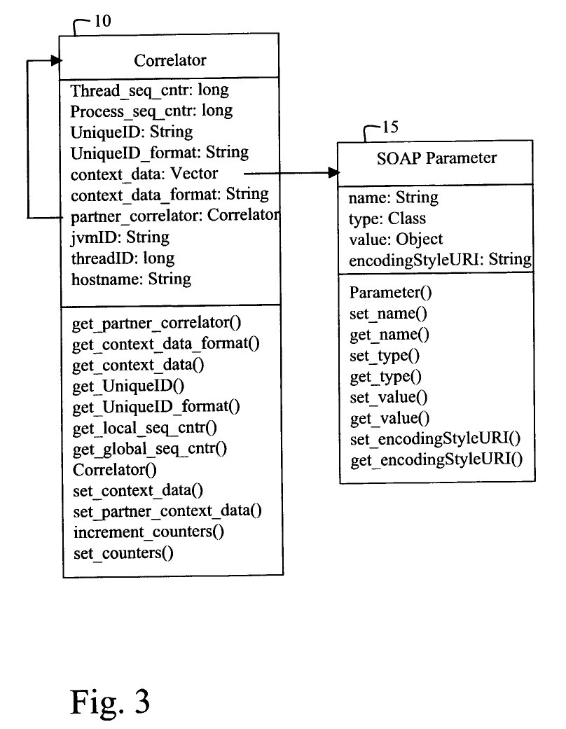

The correlation information is therefore available to a provider such as a logging/tracing; Reliability, Availability, Serviceability (RAS); Application Response Measurement (ARM); application service provider (ASP) subscriber context; or performance management service tool or application for collection and correlation with other data. In addition to providing a service for generating and transporting correlators in a distributed computing environment, the present invention provides a generic correlator for identifying events in such an environment. FIG. 3 illustrates an exemplary class data structure diagram for a correlator 10 including optional extensible context data, namely SOAP Parameter 15 described further herein below and an optional partner correlator. In accordance with the invention, the generic correlator 10 comprises the following identifiers for characteristics of the event:

Hostname—identifying the host machine where a particular process (or Java Virtual Machine (JVM)) is running;

Process Identifier (processID or jvmID)—uniquely identifying the particular process (or JVM) on a particular machine;

Thread Identifier (threadID)—identifying the current thread for a particular process;

Thread Sequence Counter (Thread_seq_cntr)—identifying an event counter for a particular thread and for a particular service provider to assist in ordering the events, for example, when clock granularity is insufficient. Also it permits the identification of the reuse of a particular thread within a process, for example, when the counter is reset to zero;

Process Sequence Counter (Process_seq_cntr)—identifying an event counter for all threads on a particular process and for all service providers serving this process to assist in ordering the events, for example, when clocks on different machines in the distributed computing environment are out of synchronization or when clock granularity is insufficient;

Provider Identifier (providerID) (not shown)—identifying the service provider associated with a particular correlator;

Unique Identifier (UniqueID)—representing the UUID for an object/event instance that is unique within the process/JVM; and

Unique Identifier Format (UniqueID_format)—identifying the format of the UUID (e.g. product, version and XML data representation, etc.).

The hostname provides a geographic location identifier indicating where the event originated while the process identifier and thread identifiers provide a logical location reference for an event specifying which event occurred. The process sequence counter and, for processes executing in more than one thread, the thread sequence counter provide temporal references giving order to particular events as described further herein below.

Additional event characteristics are useful for identifying the event. Preferably, the generic correlator data structure provides for a providerID for distinguishing correlators in situations where more than one service provider is instrumented in an application. Further the generic correlator data structure preferably includes the unique identifier and unique identifier format that provide additional instance identification capabilities to the generic correlator. The hostname and other event identifiers together with the temporal identifiers provide a generic and hierarchal convention for uniquely specifying an event. Persons skilled in the art will understand that particular events may be identified sufficiently without configuring all of the event identifier fields of the data structure, selecting geographic and location identifiers as desired.

It is further preferred that the generic correlator data structure 10 is extensible to include optional data the need for which may be determined by the service provider, for transporting between processes. In accordance with the preference SOAP Parameter class 15 defines:

Context Data (context_data)—identifying the additional information required to be transported across processes for a particular service provider;

Context Data Format (context_data_format)—identifying the format of the context data information. Exemplary context data formats include data formats defined in accordance with Simple Object Access Protocol (SOAP), an extensible markup language XML-based protocol for the exchange of information in a decentralized, distributed environment; Java Message Service (JMS) protocol or other suitable protocols.

This additional data is not required to establish a correlator, per se, but may provide additional contextual information or aid with a particular feature of the provider.

It is further preferred that the generic correlator data structure includes correlator information from a partner process. The generic data structure may include such information as follows:

Partner Correlator (partner_correlator)—identifying, in relation to a current correlator, the correlator for an event (i.e. a partner event) that triggered the particular event of the current correlator.

Correlator 10 also includes exemplary methods for setting and getting various correlator information as is understood to persons skilled in the art. Though not shown, additional methods may be included to convert or format the correlator information as desired. For example, a ToString method may be provided for converting all of the correlator information of a particular correlator to a single String data type for convenient handling. A method for incrementing the process and thread sequence counters enumerates events such that for a particular process, each event is assigned a unique count while for each thread of that particular process, and for each provider instrumented on the thread, each event is also assigned a unique count. Thus, one or more sequence counters that are responsive to characteristics of the event may be used to represent the unique temporal order of the event in a series of events requiring correlators.

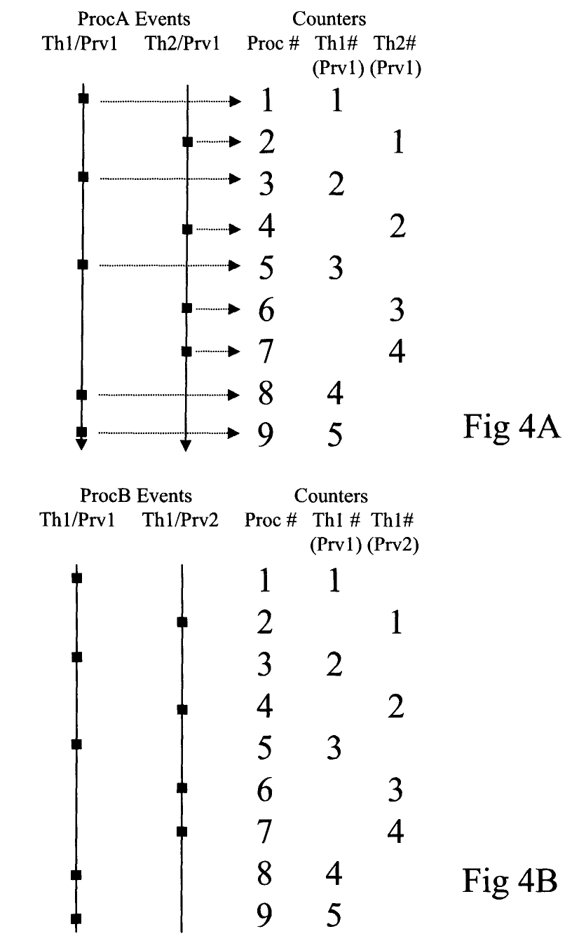

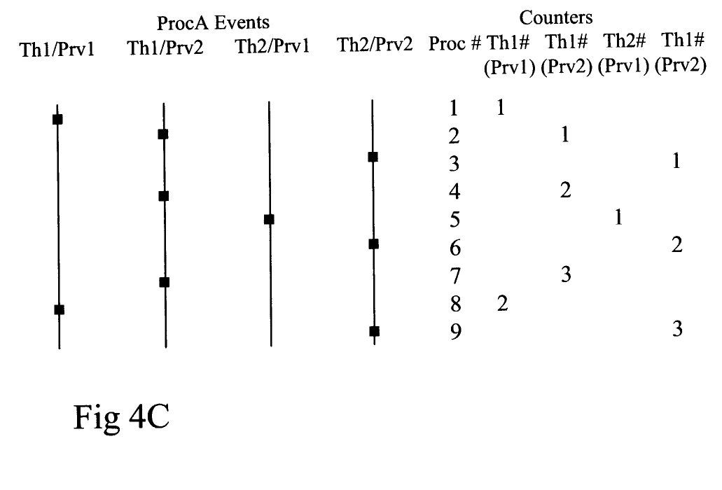

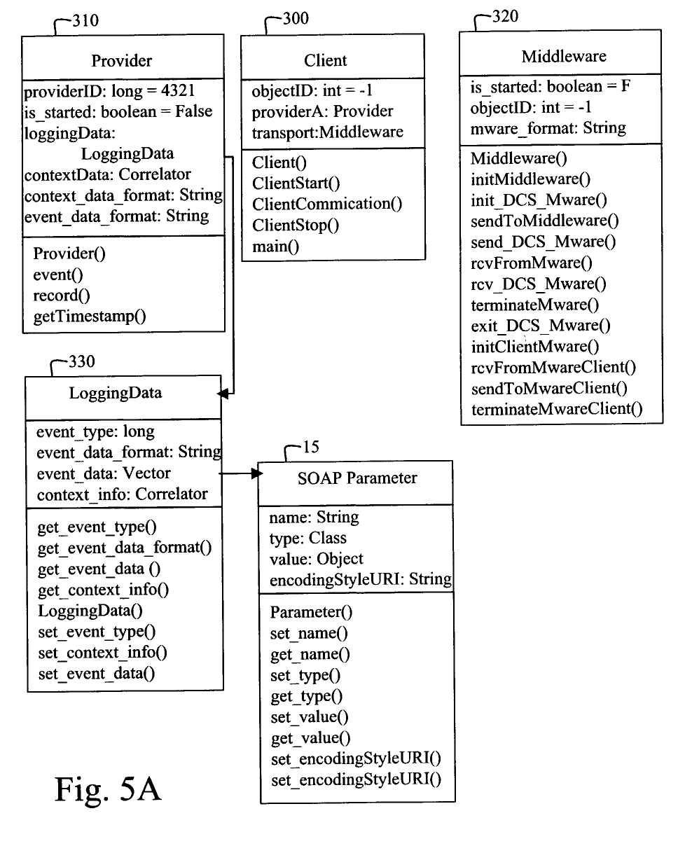

With reference to FIGS. 4A, 4B and 4C, there is illustrated the assignment of process and thread sequence counters to exemplary event occurrences for, respectively, a single provider instrumented on a multi-threaded process, multiple providers instrumented on a single threaded process and multiple providers instrumented on a multi-threaded process. For the purposes of simplification, FIGS. 4A, 4B and 4C illustrate at most two threads and two providers but it is understood that additional threads or providers are contemplated by the invention.

With reference to FIG. 4A there is illustrated an event line for each of two threads TH1 and TH2 of process ProcA instrumented by single provider, Prov1. The process sequence counter is represented by counter Proc# counting each of the nine sample events. The respective thread sequence counters TH1# and TH2# assign respective counts to the events that occur on the respective threads. Collectively, the nine events produce the following process sequence count and thread sequence count pairs (Proc#, THn#): (1,1) (2,1) (3,2) (4,2) (5,3) (6,3) (7,4) (8,4) and (9,5). As understood to persons skilled in the art, the assignment of a unique count to a process sequence counter, for example, of a correlator may be accomplished through well known steps to lock access to the counter supplying the count.

With reference to FIG. 4B there is illustrated an event line for each of two providers Prov1 and Prov2 instrumented on one thread TH1 of a process ProcB. It is noted that for the same nine sample events as depicted in FIG. 4A, the process sequence count and thread sequence count pairs are the same. With reference to FIG. 4C there is shown an event line for each of two providers Prov1 and Prov2 instrumented on two threads TH1 and TH2 of process ProcA to illustrate a further example of the assignment of a temporal identifier.

Thus the process sequence counter and thread sequence counter assign unique identifiers to event occurrences generally identified by geographic and logical identifiers within the generic correlator structure. The counters provide temporal granularity independent of a time stamp or other system clock reference.

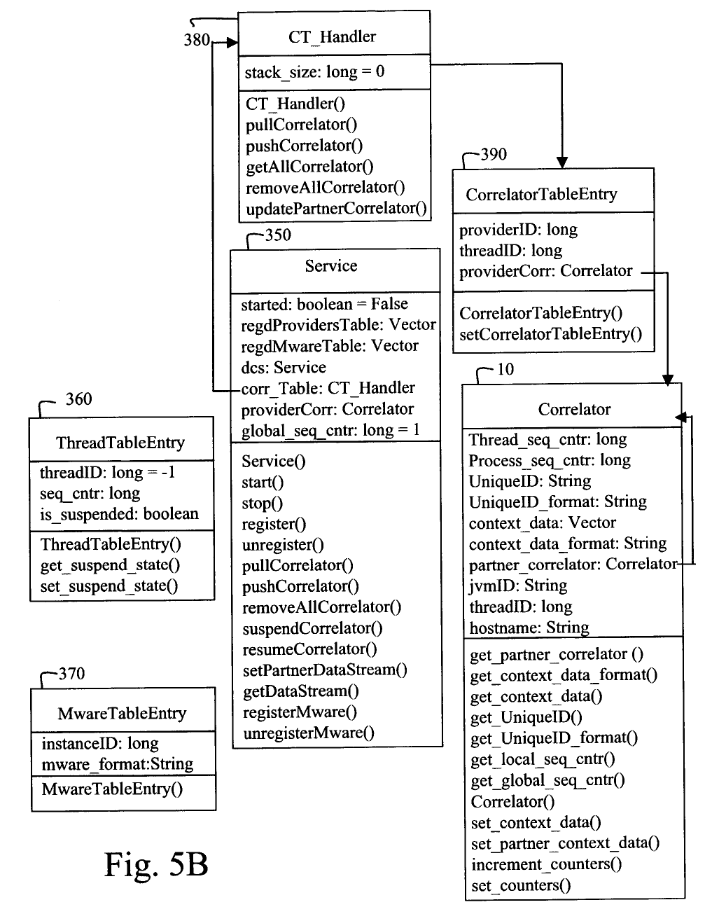

In accordance with an embodiment of the invention, there is provided an object-oriented programming model for managing correlators 10 of FIG. 3 in a distributed computing environment. FIGS. 5A-5B illustrate simplified class diagrams indicating basic functional objects and characteristics of an exemplary embodiment of a DCS service in accordance with the present invention. With reference to FIG. 5A, there is illustrated a client class 300, provider class 310, middleware class 320, logging data (LoggingData) class 330 and parameter class (SOAP Parameter) 15. With reference to FIG. 5B, there is illustrated a DCS service class (Service) 350, thread table entry class (ThreadTableEntry) 360, middleware table entry class (MwareTableEntry) 370, Correlator Table Handler class CT_Handler) 380, Correlator Table Entry class (CorrelatorTableEntry) 390 and Correlator class 10.

Briefly, client class 300 from FIG. 5A defines an exemplary client object coupled via a middleware object defined by middleware class 320 to another object (not shown) in a distributed computing environment. Provider class 310 implements an exemplary service provider, namely a distributed logging service capable of tracking and recording to a log the various events of an application such as the exemplary client objects defined by client class 300. Provider 310 provides an application programming interface (API) configured for correlating client events with corresponding events of the other process (not shown) with which the client operates via the middleware object as described. Each of the provider and middleware objects access a DCS Service defined by service class 350 of FIG. 5B for generating, storing, accessing and transporting correlators for the events of the client 300 of FIG. 5A.

As is understood to persons skilled in the art, one preferred manner of incorporating a service such as a logging provider into an application is to include invocations of the provider service at selected points in the application code that define an event of interest to be logged by the logging provider. In a distributed computing environment, particular events of interest are those involving communications, via middleware or other transport mechanisms, between the application (e.g. client) executing on one machine and another process (e.g. server) running on second machine located remotely from the first machine. These events of interest often require correlation.

Provider 310 of FIG. 5A includes various methods such as event and record for use with a logging data object defined by logging data class 330 to provide a logging service API. Logging data class 330 defines a data structure and methods for distributed logging where there is one instance of the logging data class per execution thread. Logging data class 330 provides methods for setting and getting various exemplary logging data for each event. In the example, the logging data of interest is defined in accordance with the data structures and methods of parameter class 15. In addition to setting data for local logging purposes, provider 310 configures optional data for inclusion in an event correlator 10 of FIG. 5B for transport with the generic correlation data. For example, provider 310 may configure an instance of parameter class 15 to represent a local time stamp for an event for inclusion as an element of context_data of a correlator 10 of FIG. 5B by the set_context_data method.

In order to generate, store and access event correlators for client events, provider 310 of FIG. 5A may invoke various methods of DCS Service class 350 of FIG. 5B as described further herein below.

As noted, middleware objects defined by middleware class 320 of FIG. 5A provide transport between client objects 300 and one or more other processes (e.g. server objects not shown) for the events of interest logged by the provider objects. Exemplary middleware class 320 is configured to provide objects for either client side or server side communication.

In addition to communicating the data normally required for client/server communications to complete an event, middleware class 320 is further configured in accordance with a preference of the invention to provide for transport of the correlators for the event. The correlators are preferably prepended as a header or otherwise formatted in accordance with a protocol for the middleware.

Middleware class 320 thus includes methods for typical client/server communication, including object initialization and termination and to receive and transmit in accordance with a protocol established for the middleware as is understood to persons skilled in the art. Middleware class 320 is further configured to include additional code for handling correlators and invoking methods for accessing DCS Service 350. Such additional code may remove a correlator from an inbound communication or include a correlator in an outbound communication. A correlator received on an inbound communication is configured as a partner correlator for partnering with a correlator for the thread of the process of the application receiving the communication. Middleware class 320 thus invokes methods of correlator class 10 and correlatorTableEntry class 390 to configure received data as a correlator object. Thereafter, the correlator object may be presented to DCS Service 350 for storing as a partner correlator and for linking with the appropriate correlator. Additionally, methods of the Service may be invoked to obtain the appropriate correlator for an outbound communication and for registering the middleware for the DCS Service as explained further below.

Middleware class 320 includes the following exemplary methods. InitMiddleware initializes the middleware communications streams for the server application side. Init_DCS_Mware initializes the DCS Service for a particular middleware instance. SendToMiddleware sends a data stream to a client application and send_DCS_Mware prepends a correlator data stream as a header to a data stream for transport. RcvFromMware receives the data stream sent by the client application into the server application. Rcv_DCS_Mware extracts a correlator data stream header from that data stream to establish a correlator object for partnering with another correlator. TerminateMware terminates the middleware communication stream for the server application side. Exit_DCS_Mware de-registers a middleware instance from the DCS service. Correspondingly, initClientMware initializes the middleware communications streams for the client application side. RcvFromMwareClient receives a data stream sent by the server application to the client application while sendToMwareClient sends a data stream to the server application, invoking send_DCS_Mware to prepend an appropriate correlator data stream header. TerminateMwareClient terminates the middleware communication stream for the client application side.

Referring to FIG. 5B, DCS service 350 illustrates a base class used to provide a distributed context service, managing the correlators 10 for each provider 310 into entries of a table as defined by correlator table entry class 390. Provider class 310 and middleware class 320 access Service 350.

Service 350 includes start and stop methods for respectively initiating and terminating the DCS service class. To facilitate the registration and de-registration with the DCS Service of middleware identified by an instanceID, there is provided a registerMiddleware method and an unregisterMiddleware method as well as a middleware table defined by MwareTableEntry 370.

Register and unregister methods facilitate registration and de-registration with the DCS service of a provider identified by a providerID. Preferably, the DCS service class is started before a register method is invoked. Otherwise, the DCS service may be started by the register method. The unregister method may stop the DCS service if there are no providers or middleware that remain registered with the DCS Service.

Other methods are provided for storing and accessing a correlator with the DCS Service. For example, pushCorrelator enters a correlator into the correlator table (via classes CT_Handler 380 and CorrelatorTableEntry 390) to make the correlator available to middleware (via the DCS Service) for transporting on an outbound call from client 300. PullCorrelator retrieves a provider's correlator from the DCS service correlator table. By pulling a correlator from the service class, the thread sequence counter and process sequence counter are incremented by the DCS service class as discussed previously.

The removeAllCorrelator method removes all correlator entries (regardless of threadID) from the correlator table for a particular provider. The suspendcorreletor method (assisted by ThreadTableEntry class 360) suspends a provider from updating a correlator for a particular thread until the resumeCorrelator method is invoked for the particular correlator. Preferably, a correlator may be updated even if suspended, to include a partner correlator.

SetPartnerDataStream method, invoked by a middleware, sets the partner correlator for all providers identified in the correlator received by the middleware on an inbound call. The GetDataStream method provides to a middleware the correlator for a particular threadID in a byte stream, preferably in a format supported by the middleware, to transport on an outbound middleware call.

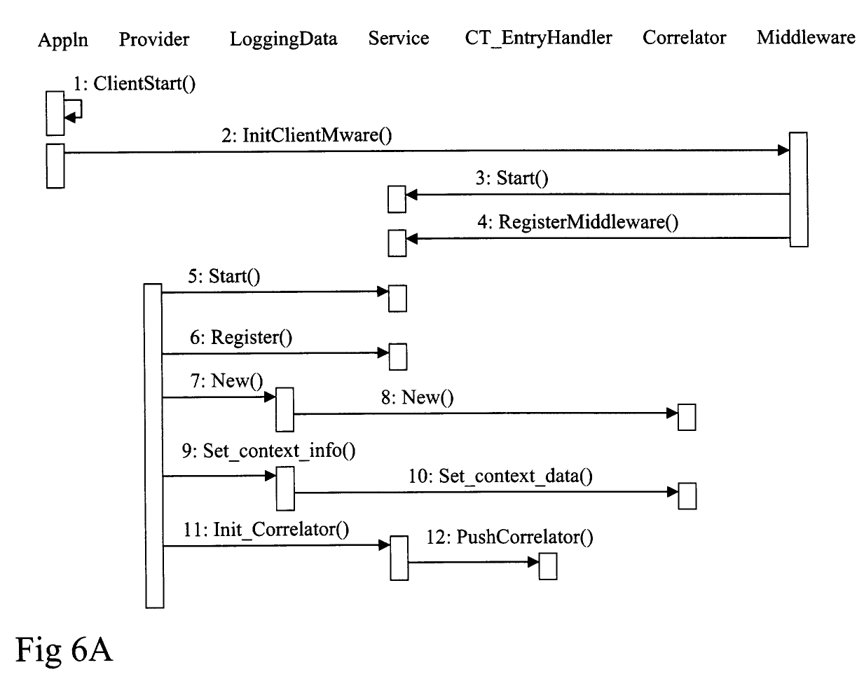

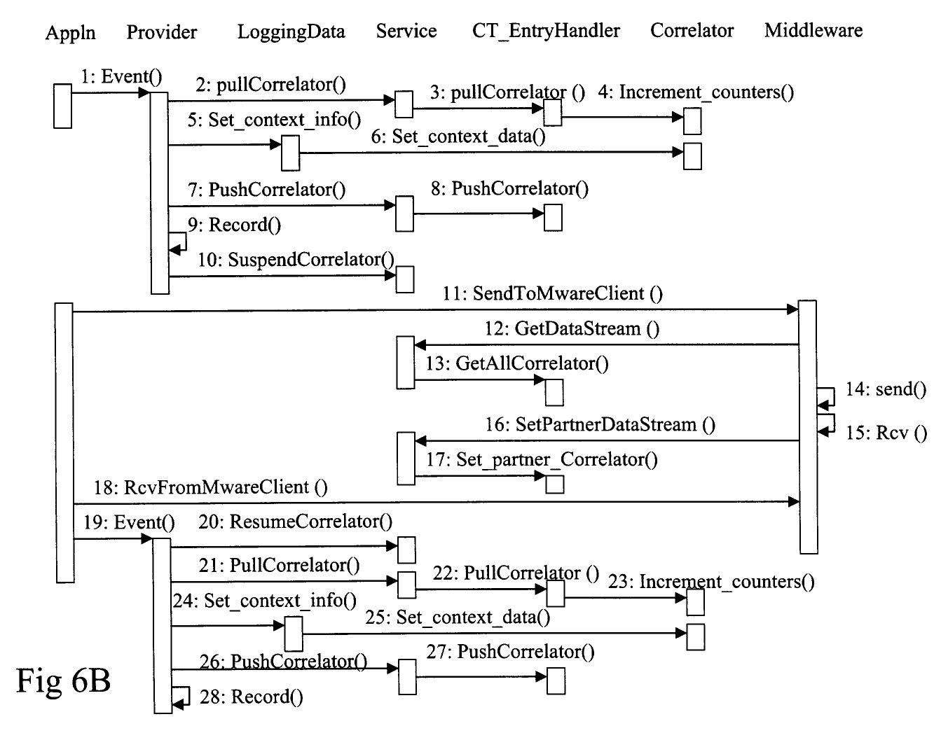

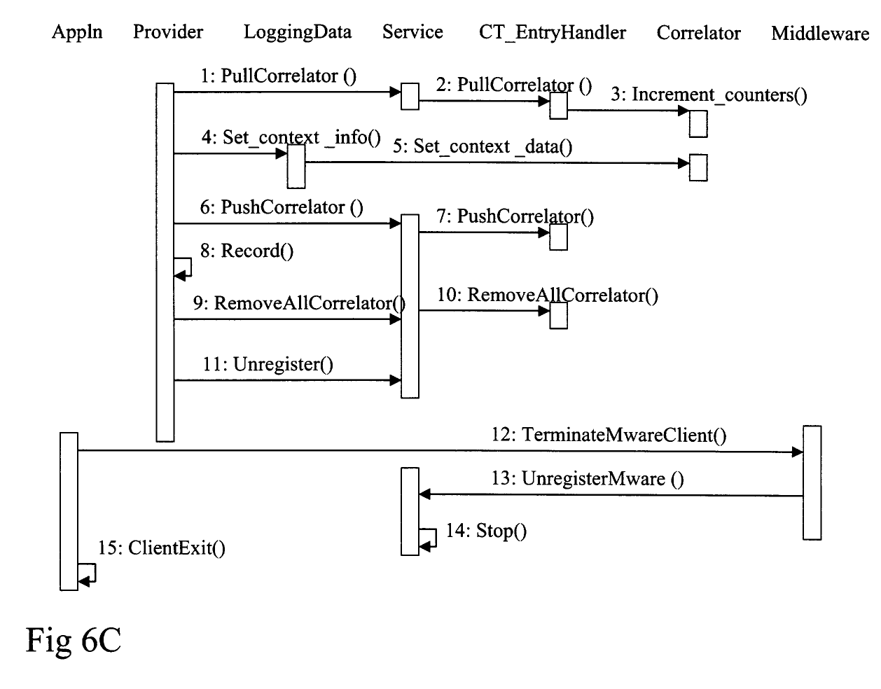

FIGS. 6A, 6B and 6C illustrate a calling sequence for the classes of FIGS. 5A and 5B, for generating and transporting correlators. With reference to the call flow of FIG. 6A, an instance of an application such as client class 300 of FIG. 5A performs a self-initialization at call 1 (ClientStart( )) and at call 2 performs a first call to the transport mechanism (a middleware plug-in instance of class 320). Middleware plug-in 320 of FIG. 5A starts an instance of service class 350 at call 3 and if such is successful, registers with the service instance at call 4, providing a middleware instanceID. An instance of provider service class 310, is instantiated by client 300 (not shown) and the provider calls start( ) of the DCS service 350 of FIG. 5B at call 5 to ensure the service is started. If so, the provider instance registers with the service at call 6. Provider proceeds to configure a new logging data object including a correlator at calls 7 and 8. Provider desires a certain optional SOAP parameter 15 (e.g. a time stamp) to be included in the new correlator 10 of FIG. 5A and invokes a method of the logging data 330 to add the parameter 15 of FIG. 5B (call 9) which in turn calls correlator class object 10 to set the optional data into the correlator at call 10. Once a correlator is populated with the parameter, the correlator is stored with the service 350 by provider 310 at call 11. The provider passes the threadID and providerID for the correlator to the DCS service to facilitate the completion of a new correlator. The service in turn invokes the CT_EntryHandler class 390 to store the correlator instance 10. The provider 310 is now ready to handle particular events of client 300.

FIG. 6B shows a calling sequence for an exemplary cross product/process calling sequence. Application 300 signals an event to provider 310 (call 1) which pulls a correlator from the service (call 2) for the process and thread instance of application 300. In turn, CT_EntryHandler pulls the identified correlator from the table (call 3) and invokes a method of the correlator class 10 (call 4) to increment the thread sequence counter and process sequence counter, storing the values in the correlator before returning same back to the requesting provider plug-in. Provider plug-in updates particular desired optional parameters through a logging data class call 5 that in turn updates the correlator at call 6. The updated correlator is stored with the service at calls 7 and 8. Provider plug-in records the logging data including the correlator at call 9 and requests service to suspend activity for the particular correlator at call 10.

At call 11 of FIG. 6B, application 300 invokes the transport via middleware plug-in to perform a cross process/product function call or communication. At call 12, middleware requests all correlators for the particular threadID from service 350 as a data stream to transport with the outgoing communication. At call 13, service requests all context for the threadID from the CT_EntryHandler. At call 14, middleware sends the communication including the correlator. Upon return of a response to the communication at call 15, middleware removes the returning correlator and passes same to service at call 16 for setting as a partner correlator at call 17. Application receives the response at call 18 to the send of call 11 and invokes the provider plug-in to note a new event. Provider resumes the previously suspended correlator at call 20 and pulls the correlator from service at call 21. This provokes a pull from the CT_entryHandler at call 22 and a corresponding increment of the thread sequence counter and provider sequence counter to uniquely identify the event. Call 24 to logging data and corresponding call 25 to the correlator object sets context data into the correlator while calls 26 and 27 push the updated correlator back into the service and its table. Call 28 by provider plug-in records the logging data including the correlator. Note that a retrieval of a correlator (i.e. pullcorrelator( )) having an associated partner correlator provides an opportunity to flush the partner correlator from the correlator, once the association has been logged, so that subsequent uses of the correlator do not include references to a potentially misleading partner correlator.

FIG. 6C shows a calling sequence to bring down the service and the provider for a particular thread of an application. Calls 1 through 3 show a final pull of a correlator from the service and its table, triggering an increment of the counters. Provider plug-in calls to set context data into the correlator through logging data class at calls 4 and 5. The updated correlator is returned to the service and table at calls 6 and 7 and the logging data recorded at call 8. To bring down the service for the thread, provider plug-in requests that all correlators for the thread be removed by the service at call 9. Following removal of the correlators through the table entry handler 390 of FIG. 5C at call 10, the provider de-registers with the service at call 11 and exits from the transport at call 12. Middleware also de-registers from service at call 13. Service stops at call 14, having nothing further to serve. Application may also invoke a self-stop method at call 15.

The embodiment(s) of the invention described above is (are) intended to be exemplary only. The scope of the invention is therefore intended to be limited solely by the scope of the appended claims.

We claim:

1. A method for providing a correlator for an event of a series of events, said method comprising:
generating a correlator comprising an event identifier and a temporal identifier, said event identifier comprising one or more identifiers selected from the group comprising: a geographical identifier of said event; and a logical identifier of said event;
wherein said temporal identifier representative of the order of said event in said series of events.

2. The method as claimed in claim 1 wherein the step of generating comprises counting each event using one or more sequential counters each responsive to a characteristic of the event and wherein the temporal identifier comprises a count from one or more of the one or more sequential counters.

3. The method as claimed in claim 2 wherein a first characteristic of the event is defined by a process generating the event and wherein one of the sequential counters defines a process sequential counter responsive to the first characteristic to count all of the events of the said process and wherein the temporal identifier comprises a count of the process sequential counter.

4. The method as claimed in claim 3 wherein a second characteristic of the event is defined by a thread of the process generating the event and wherein one of the sequential counters defines a thread sequential counter responsive to the second characteristic to count all of the events of the said thread of the process and wherein the temporal identifier comprises a count of the thread sequential counter.

5. A method for providing a correlator for an event of a series of events occurring on a computer and for which correlators are desired, the method comprising steps of:
determining an event identifier comprising data representative of one or more identifiers selected from the group consisting of geographical identifiers and logical identifiers for the event;
assigning a temporal identifier comprising data representative of the unique temporal order of the event in the series of events;
generating the correlator comprising the event identifier and the temporal identifier for the event.

6. The method as claimed in claim 5 wherein the step of assigning comprises counting each event using one or more sequential counters each responsive to a characteristic of the event and wherein the temporal identifier comprises a count from one or more of the one or more sequential counters.

7. The method as claimed in claim 6 wherein a first characteristic of the event is defined by a process generating the event and wherein one of the sequential counters defines a process sequential counter responsive to the first characteristic to count all of the events of the said process and wherein the temporal identifier comprises a count of the process sequential counter.

8. The method as claimed in claim 7 wherein a second characteristic of the event is defined by a thread of the process generating the event and wherein one of the sequential counters defines a thread sequential counter responsive to the second characteristic to count all of the events of the said thread of the process and wherein the temporal identifier comprises a count of the thread sequential counter.

9. The method as claimed in claim 8 wherein a third characteristic of the event is defined by a provider requiring the correlator and wherein the thread sequential counter is further responsive to the third characteristic to count all of the events of the said thread for the said provider.

10. The method as claimed in claim 5 including the step of providing a generic correlator data structure for defining the correlator, the data structure comprising means for defining the event identifier and the temporal identifier; and wherein the step of generating comprises configuring an instance of the data structure.

11. The method as claimed in claim 10 wherein the generic correlator data structure further comprises means for defining optional context information and wherein the method further comprises the steps of:
determining data representative of an instance of the optional context information; and
configuring the instance of the data structure with the data representative of the instance of the optional context information.

12. The method as claimed in claim 11 wherein the means for defining the optional context data is configured in accordance with a protocol for the exchange of information.

13. The method as claimed in claim 10 wherein the generic correlator data structure further comprises means for defining an association between the correlator for the event and a partner correlator comprising a correlator for a second event and wherein the method further comprises the steps of:
determining data representative of the association with the partner correlator; and
configuring the instance of the data structure for the event with the association.

14. The method as claimed in claim 13 including the steps of:
receiving data for defining a partner correlator for the event; and
generating an instance of the generic data structure for the partner correlator in accordance with the data received.

15. The method as claimed in claim 5 wherein the computer is coupled to one or more other computers in a distributed computer system and wherein the method further includes the step of providing the correlator for transporting to a first one of the other computers for association with a correlator of a second one of the other computers.

16. The method as claimed in claim 5 including the step of providing the correlator for use to identify the event.

17. The method as claimed in claim 5 wherein the event identifier is selected in accordance with a hierarchical convention for identifying events.

18. A computer readable medium containing executable program instructions for providing a correlator for an event of a series of events occurring on a computer and for which correlators are desired, the computer program medium comprising programming instructions for:
determining an event identifier comprising data representative of one or more identifiers selected from the group consisting of geographical identifiers and logical identifiers for the event;
assigning a temporal identifier comprising data representative of the unique temporal order of the event in the series of events from one or more sequential counters each responsive to a characteristic of the event;
generating the correlator comprising the event identifier and the temporal identifier for the event.

19. The computer program product as claimed in claim 18 wherein a first characteristic of the event is defined by a process generating the event and wherein one of the sequential counters defines a process sequential counter responsive to the first characteristic to count all of the events of the said process and wherein the temporal identifier comprises a count of the process sequential counter.

20. The computer program product as claimed in claim 19 wherein a second characteristic of the event is defined by a thread of the process generating the event and wherein one of the sequential counters defines a thread sequential counter responsive to the second characteristic to count all of the events of the said thread of the process and wherein the temporal identifier comprises a count of the thread sequential counter.

21. The computer program product as claimed in claim 20 wherein a third characteristic of the event is defined by a provider requiring the correlator and wherein the thread sequential counter is further responsive to the third characteristic to count all of the events of the said thread for the said provider.

22. The computer program product as claimed in claim 18 further comprising program instructions for:
determining data representative of optional context information for the event; and
generating the correlator with the data representative of the optional context information.

23. The computer program product as claimed in claim 22 including program instructions for configuring the data representative of optional context information for the event in accordance with a protocol for the exchange of information.

24. The computer program product as claimed in claim 18 further comprising program instructions for:
defining data representative of an association between the correlator for the event and a partner correlator comprising a correlator for a second event; and
generating the correlator with the data representative of the association.

25. The computer program product as claimed in claim 24 including programming instructions for:
receiving data for defining a partner correlator for the event; and
generating the partner correlator in accordance with the data received.

26. The computer program product as claimed in claim 18 wherein said computer is coupled to one or more other computers in a distributed computer system and wherein the computer program product further comprises programming instructions for transporting the correlator to a first one of the other computers for association with a correlator of a second one of the other computers.

27. The computer program product as claimed in claim 18 including the step of providing the correlator for use to identify the event.

28. A correlator for an event in a series of events, said correlator comprising:
an event identifier comprising one or more identifiers selected from the group comprising: a geographical identifier of said event; and a logical identifier of said event; and
a temporal identifier representative of the order of said event in said series of events.

29. The correlator as claimed in claim 28 further comprising an association to a second correlator defining a partner correlator.

30. A data structure stored on a computer readable medium representing a correlator, said data structure comprising:
a field for an event identifier comprising data representative of one or more identifiers selected from the group consisting of geographical identifiers and logical identifiers for the event; and
a field for a temporal identifier comprising data representative of the unique temporal order of the event in the series of events from one or more sequential counters each responsive a characteristic of the event.

31. The data structure as claimed in claim 30 further comprising a field for optional context information configured in accordance with a protocol for the exchange of information.

32. The data structure as claimed in claim 31 further comprising a field for providing an association to a partner correlator.
